(19) United States
(12) Patent Application Publication
(10) Pub. No.: US 2014/0021144 A1
(43) Pub. Date: Jan. 23, 2014

(54) Filtering Device and Method

(71) Applicant: TRYANGLE, INC., Costa Mesa, CA (US)

(72) Inventor: Mark James Lane, Norco, CA (US)

(73) Assignee: Tryangle, Inc., Costa Mesa, CA (US)

(21) Appl. No.: 13/795,351

(22) Filed: Mar. 12, 2013

Related U.S. Application Data
(60) Provisional application No. 61/674,584, filed on Jul. 23, 2012.

(51) Int. Cl. B01D 39/16

(52) U.S. Cl. CPC B01D 39/163
USPC 210/767; 210/508; 210/489; 210/170.03

(57) ABSTRACT

A filtering device and method is provided for filtering debris from liquid flowing over a surface. The device includes a flexible, liquid-permeable elongated body possessing a plurality of faces including a planar bottom face configured to rest on the surface. The liquid-permeable elongated body is formed of a plurality of compressed fibers and an adhesive bonding together the fibers. The device may be arranged on the ground on a construction site to inhibit loose debris from being washed away by rainwater into storm drains and nearby bodies of liquid.

This application is a non-provisional application of and claims priority to U.S. Patent Application Ser. No. 61/674,584, filed on Jul. 23, 2012, the content of which is incorporated herein by reference in its entirety for all purposes.

### TECHNICAL FIELD

The present application generally concerns a device and method for filtering debris from water flowing over a surface. The device may be deployed on a construction site where loosened ground material and other debris can be washed away by rainwater into storm drains and nearby natural water bodies.

### BACKGROUND

The construction of buildings, roads, and other outdoor structures generally involves excavating and transporting ground materials such as rocks, silt, sand, and soil. Some of the excavated ground material is re-deposited in loosely-packed piles on the construction site. Oftentimes the excavated ground material is inadvertently scattered about the construction site as the excavated ground material is transported about the construction site. The tires and treads of cars, trucks, earth-moving machines, and other machinery moving about the construction site also cause the loosening of ground material. Other debris that may be loosely scattered about the construction site includes construction materials such as bricks and gravel as well as waste materials such as broken or chipped concrete and asphalt.

During a rainstorm, rainwater flows over the surface of the construction site and carries away some of the excavated ground material and other debris loosely deposited around the construction site. If barriers, natural or otherwise, do not exist to impede the flow of rainwater, the rainwater will carry the debris into nearby natural water bodies such as streams, rivers, lakes, ponds, and wetlands. Debris is also carried by the rainwater into storm drains located about the construction site. Storm drains are oftentimes constructed in the early phases of construction before loosened ground debris is cleared from the construction site, thereby creating a risk of debris flowing directly into the storm drain. Storm drains are sometimes installed before the paving of the roads of the construction site. Vehicles traveling over the unpaved roads loosen ground material making it susceptible to being washed into the storm drains by rainwater. The issue of rainwater carrying away debris exists both on construction sites where new structures are being built as well as construction sites where existing structures are being renovated or modified.

Various government regulations limit the amount of debris which can be washed away by rainwater from a construction site. These regulations oftentimes restrict changes in various water properties of natural water bodies that receive rainwater runoff from the construction site and/or rainwater from storm drains located on the construction site. The water properties of the natural water bodies are affected by the debris carried away by the rainwater from the construction site. Water properties which are regulated include, among other properties, the pH level and turbidity level of the nearby natural water bodies. Recently, government regulations have become more restrictive in that the regulations permit less debris to be washed away from construction sites. Failure to comply with the regulations can result in fines and/or the loss of construction permits.

In the past, temporary barriers such as straw wattles and gravel bags were placed near storm drains and other locations about the construction site to prevent debris from being washed away by rainwater. A straw wattle is a tubular net filled with rice straw. Straw wattles and gravel bags tend to break apart overtime after repeated exposure to weather conditions such as rain, wind, sun, and temperature changes. Straw wattles and gravel bags also tend to break apart when rolled over by vehicles and other machinery moving about the construction site. A broken-apart straw wattle or gravel bag may disintegrate into smaller pieces thereby increasing the loose ground debris of the construction site. Straw wattles and gravel bags therefore tend to exacerbate the problem of debris being washed away from the construction site. Straw wattles and gravel bags also tend to get pushed out of position by passing vehicles, rainwater, and wind. When not properly positioned, for example in front of a storm drain inlet or near a debris pile, a straw wattle or gravel bag will not serve its function of preventing debris from being washed away by rainwater. Some states and cities prevent the use of straw wattles on paved surfaces. In these jurisdictions, straw wattles cannot be positioned in front of a storm drain inlet on a paved street. Straw wattles and gravel bags typically cannot be re-used because they tend to break apart over time and because they cannot easily be cleaned of the debris which they have captured.

In view of the foregoing, prior to the present invention, a need existed for a relatively durable filtering device capable of filtering debris from construction site rainwater runoff.

### SUMMARY

A device for filtering debris from liquid flowing over a surface is provided. The device includes a flexible, permeable elongated body possessing a plurality of faces including a planar bottom face configured to rest on the surface. The permeable elongated body is configured so that with the permeable elongated body resting on the surface, liquid flowing over the surface contacts at least one of the faces of the permeable elongated body, passes through the permeable elongated body, and flows out of the permeable elongated body through at least one other of the faces of the permeable elongated body. The permeable elongated body filters a portion of the debris from the liquid as the liquid passes through the permeable elongated body. The permeable elongated body is formed of a plurality of compressed rubber fibers and an adhesive bonding together the rubber fibers.

A method of filtering debris from liquid flowing over a surface is also provided. The method includes positioning on the surface a flexible, permeable elongated body possessing a plurality of faces and a plurality of compressed, adhesive-bonded fibers so that the liquid flowing over the surface flows towards the permeable elongated body. The positioning of the permeable elongated body includes arranging the permeable elongated body so that the liquid flowing towards the permeable elongated body contacts at least one of the faces of the permeable elongated body, passes through the permeable elongated body, and flows out of the permeable elongated body through at least one other of the faces of the permeable elongated body. The liquid passing through the permeable elongated body is filtered to remove at least a portion of the debris from the liquid as the liquid passes through the permeable elongated body.

In addition, a filtering device positioned on a surface which conveys liquid carrying debris is provided. The filtering device includes a flexible, permeable elongated body possessing a plurality of faces including a planar bottom face resting on the surface. The filtering device is formed of a plurality of compressed fibers and an adhesive bonding together the fibers. The filtering device is positioned on the surface so that the liquid contacts at least one of the faces of the permeable elongated body, passes through the permeable elongated body, and flows out of the permeable elongated body through at least one other of the faces of the permeable elongated body, wherein the permeable elongated body filters a portion of the debris from the liquid as the liquid passes through the permeable elongated body.

### BRIEF DESCRIPTION OF THE DRAWINGS

Objects and advantages of the invention will become apparent upon reading the following detailed description and upon reference to the drawings, in which:

FIG. 1 is a perspective view of a first embodiment of a filtering device;

FIG. 2 is cross-sectional view of the filtering device taken along line 2-1 of FIG. 1;

FIG. 3 is a is a close-up view of an end portion of the filtering device;

FIG. 4 shows the filtering device surrounding a debris pile;

FIG. 5 shows the filtering device linearly arranged along a sidewalk;

FIG. 6 is a cross-sectional view of the filtering device possessing a fabric layer; and

FIG. 7A illustrates a gutter inlet;

FIG. 7B depicts a curb inlet;

FIG. 7C shows a combination inlet;

FIG. 8 illustrates a perspective view of a second embodiment of the filtering device;

FIG. 9 illustrates a top view of the second embodiment of the filtering device;

FIG. 10 depicts a raw view of the second embodiment of the filtering device;

FIG. 11 illustrates a cross-sectional view of the second embodiment of the filtering device taken along line 11-1 of FIG. 8;

FIG. 12 shows the second embodiment of the filtering device arranged adjacent a pavement inlet;

FIG. 13 is a cross-sectional view of the second embodiment of the filtering device possessing a fabric layer;

FIG. 14 is a perspective view of a third embodiment of the filtering device;

FIG. 15 shows the third embodiment of the filtering device arranged adjacent a pavement inlet; and

FIG. 16 is a cross-sectional view of the third embodiment of the filtering device possessing a fabric layer.

### DETAILED DESCRIPTION

While the present invention will be described in connection with specific embodiments, it will be understood that the claimed invention is not limited to specific disclosed embodiments. On the contrary, the description is intended to cover all alternatives, modifications, and equivalents as may be included within the spirit and scope of the present invention as defined by the appended claims.

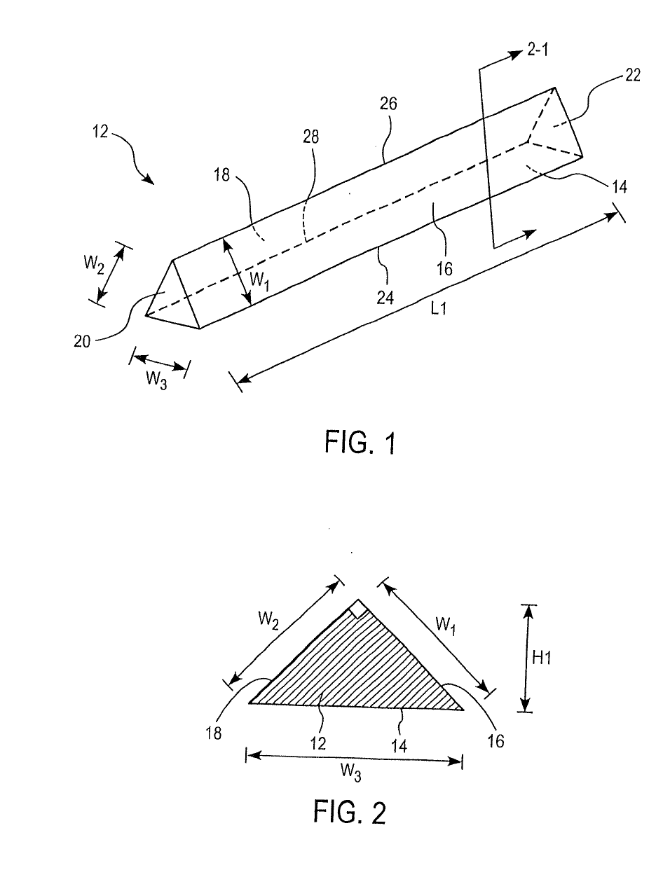

FIGS. 1-6 illustrate a first embodiment of a filtering device including an elongated body 12 possessing a bottom face 14, first and second side faces 16 and 18, and first and second end faces 20 and 22. The elongated body 12 possesses a length L1 extending between the first and second end faces 20 and 22 along a longitudinal axis of the elongated body 12. The first side face 16 possesses a width W1 extending between edges 24 and 26. The second side face 18 possesses a width W2 extending between edges 26 and 28. The bottom face possesses a width W3 extending between edges 24 and 28.

FIG. 2 illustrates a cross-sectional view of the elongated body 12 taken along line 2-1 of FIG. 1. Line 2-1 is an imaginary line orthogonal to the longitudinal axis of the elongated body 12. FIG. 2 depicts the bottom face 14 being substantially planar (that is, flat) across the entire width W3. In other embodiments, only a portion of the bottom face 14 is planar. FIG. 2 shows that the first and second side faces 16 and 18 are angled relative to the bottom face 14 so that the cross-section of the elongated body 12 is generally triangular. The first and second side faces 16 and 18 orthogonally intersect each other (that is, the first and second side faces 16 and 18 form a 90 degree angle) and possess equal widths (that is, W1 equals W2). In other embodiments, the first and second side faces 16 and 18 do not orthogonally intersect and/or do not possess equal widths.

The widths W1 and W2 of the first and second side faces 16 and 18 are generally between 3 and 8 inches. In one embodiment, the widths W1 and W2 of the first and second faces 16 and 18 are each 3 inches. In another embodiment, the widths W1 and W2 of the first and second faces 16 and 18 are each 6 inches. In yet another embodiment, the width W1 and W2 of the first and second faces 16 and 18 are different. The length L1 of the elongated body 12 generally does not exceed 10 feet, but the length L1 may be any desired length.

The elongated body 12 may be formed of a plurality of compressed rubber fibers bonded together with an adhesive. The rubber fibers may be obtained by shredding recycled rubber car ties and/or other recycled rubber products. The rubber fibers may be made of styrene-butadiene rubber and the like. The rubber is shredded into fibers each possessing a length generally between 0.5 and 1.5 inches and a width generally less than 1/16 inch. The rubber fibers are mixed with the adhesive and then pressed into the shape of the elongated body 12. SpectraPour 1165 binder and other similar binders may be used as the adhesive. For every cubic foot of rubber fibers, approximately 10 cups of adhesive is used.

A mold or form may be used to hold the rubber fibers as they are pressed into the desired shape. The mold or form may possess an open end so that a portion of rubber fibers is exposed. A roller may be used to roll over and smoothen the exposed portion of rubber fibers so that the rubber fibers take the shape of the form or mold. The pressing operation may be performed at room temperature.

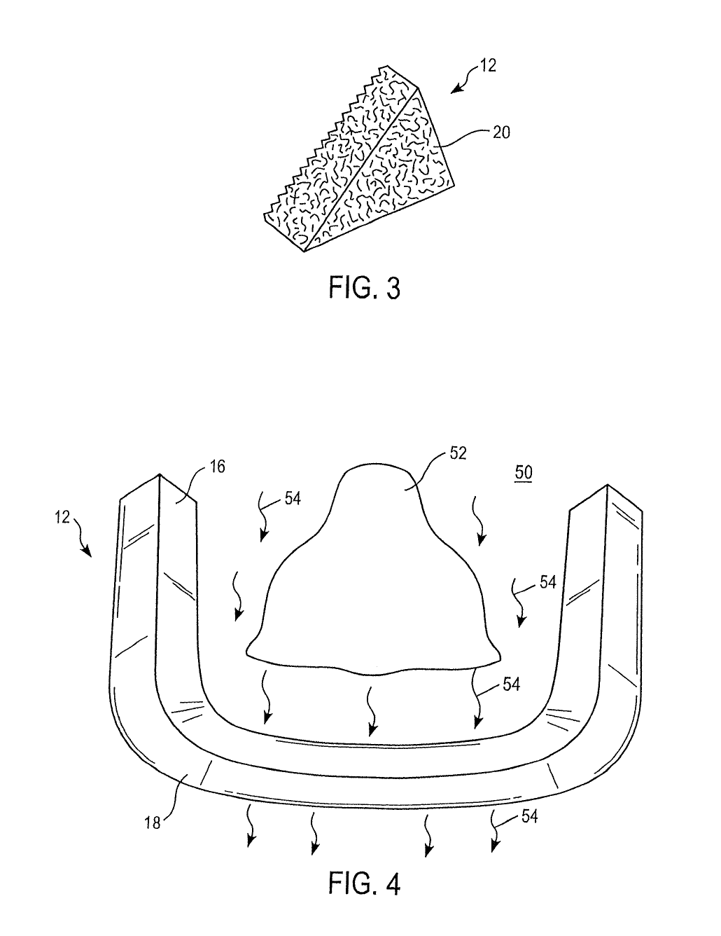

In one embodiment, the rubber fibers are randomly oriented relative to each other after being pressed into the shape of the elongated body 12. FIG. 3 is a close-up view of an end portion of the elongated body 12 possessing a plurality of randomly oriented rubber fibers.

The porosity of the elongated body 12 (that is, the empty space between the rubber fibers of the elongated body 12) is at least partially dependent upon the compressive force used to press the rubber fibers together. A higher compressive force decreases the amount of empty space between the rubber fibers and results in a lower porosity of the elongated body 12. The elongated body 12 is preferably permeable (e.g., the elongated body 12 may be water-permeable), and so a compressive force is used that results in at least some spacing between the rubber fibers. The porosity of the elongated body 12 is such that a liquid, such as water, can pass through the elongated body 12, but construction site debris, such as gravel, rocks, silt, sand, and chipped or broken concrete and asphalt, etc., generally cannot pass through the elongated body 12.

Too much porosity of the elongated body 12 can result in the elongated body 12 not being sufficiently dense. There is a risk that the elongated body 12 will be pushed out of position by a flow of water if the elongated body 12 is not sufficiently dense. The risk of water moving of the elongated body 12 out of position is increased if the elongated body 12 is less dense than water. There is also a possibility that a passing vehicle will push the elongated body 12 out of position if the elongated body 12 is too light. As such, the compressive force used to press the rubber fibers into the shape of the elongated body 12 is high enough to impart the elongated body 12 with a sufficient density.

Pressing the rubber fibers with a compressive force of approximately 0-10 lbs. when the rubber fibers are in the mold or form has found to impart the elongated body 12 with an appropriate porosity and/or density.

The elongated body 12 is flexible so that the elongated body 12 can be bent into a variety of shapes such as a semicircle or u-shape. The elongated body 12 elastically deforms when it is bent, and so it is possible to bend the elongated body 12 back to its original linear shape illustrated in FIG. 1, if necessary. The flexibility of the elongated body 12 enables the elongated body 12 to elastically compress when a vehicle passes over the elongated body 12 so that the elongated body 12 does not undergo plastic deformation. This aspect of the elongated body 12 contributes to the durability and usable lifespan of the elongated body 12.

FIG. 4 illustrates the elongated body 12 being positioned on a surface 50 and bent to partially surround a debris pile 52. The planar bottom face 14 rests against the surface 50. The surface 50 may be a paved or an un-paved surface of a construction site. The debris pile 52 may include, for example, excavated ground materials such as rocks, silt, sand and/or soil, and additionally, construction materials such as gravel, bricks, chipped or broken concrete, chipped or broken asphalt, and/or construction waste materials. The debris pile 52 may be loosely packed such that the water 54 (e.g., rainwater) flowing over the surface 50 carries at least a portion the debris away from the debris pile 52.

FIG. 4 illustrates positioning the elongated body 12 downstream of the debris pile 52 so that the water 54 carrying the debris away from the debris pile 52 flows towards the elongated body 12. The water 54 carrying the debris contacts the first side face 16 of the elongated body. The water 54 then passes through the elongated body 12 because the elongated body 12 is permeable. The empty space between the rubber fibers of the elongated body 12 permits the water 54 to pass through the elongated body 12. After passing through the elongated body 12, the water 54 flows out of the elongated body 12 through the second side face 18.

The debris carried by the flow of water 54 is substantially filtered from the water 54 as the water passes through the elongated body 12. This is because at least some of the debris is not small enough to pass through the empty spaces between the rubber fibers of the elongated body 12. As such, the rubber fibers inhibit the debris carried by the water 54 from passing through the elongated body 12. The debris which does not pass through the elongated body 12 either gathers at the base of the first side face 16 illustrated in FIG. 4 or becomes trapped inside the elongated body 12.

Because debris is substantially filtered from the water 54, the water 54 flowing out of the elongated body 12 may have a different pH and/or a different turbidity than the water 54 flowing into the elongated body 12. For example, the water 54 flowing out of the elongated body 54 may have a lower pH and/or a lower turbidity than the water 54 flowing into the elongated body 12. This aspect of the elongated body 12 may help a construction site operator comply with government regulations regulating the water properties of construction site rainwater runoff.

The flow of water 54 may be slowed as the water 54 passes through the elongated body 12. This may cause water 54 to build up near the side face of the elongated body 12 through which the water 54 flows into the elongated body 12. For example, the water may build up near the first side face 16 illustrated in FIG. 4. The elongated body 12 possesses a height H1 which lessens the possibility of the water 54 rising to a level where the water 54 flows over the top of the elongated body 12. The elongated body 12 may be less effective in removing debris from the water 54 if the water 54 flows over the top of the elongated body 12. In one embodiment, the first and second side faces 16 and 18 possess respective widths W1 and W2 of about 6 inches so that the height H1 of the elongated body 12 is approximately 7.3 inches. Using an elongated body 12 with these dimensions may be preferable when the water 54 carries debris such as sand, gravel, and/or broken piles of concrete and asphalt. An elongated body 12 with respective widths W1 and W2 of 6 or 8 inches can serve as a suitable substitute for two stacked gravel bags.

Vehicles such as cars, trucks, and earth-moving machinery may pass over the elongated body 12 after the elongated body 12 has been arranged on the surface 50 to filter debris from the water 54 flowing over the surface 50. The wheels and/or treads of these vehicles may exert a lateral force (that is, a force which is substantially parallel to the surface 50) against the elongated body 12. The planar bottom face 14 of the elongated body 12 hinders the lateral force exerted by the passing vehicle from toppling the elongated body 12 and/or moving the elongated body 12 from its original position. The planar bottom face 14 also helps prevent the flow of the water 54 from pushing the elongated body 12 out of position. Vehicles may pass over the elongated body 12 in multiple directions. An embodiment of the elongated body 12 possessing first and second side faces 16 and 18 with equal widths W1 and W2 helps ensure that a vehicle experiences a similar impulse (i.e., jolt) whether passing over the elongated body 12 in a first direction or a second direction.

An additional measure to inhibit the elongated body 12 from being moved out of position is to drive a stake or spike through the elongated body 12 and into the ground beneath elongated body 12. Wooden and/or steel spikes can be used for this purpose.

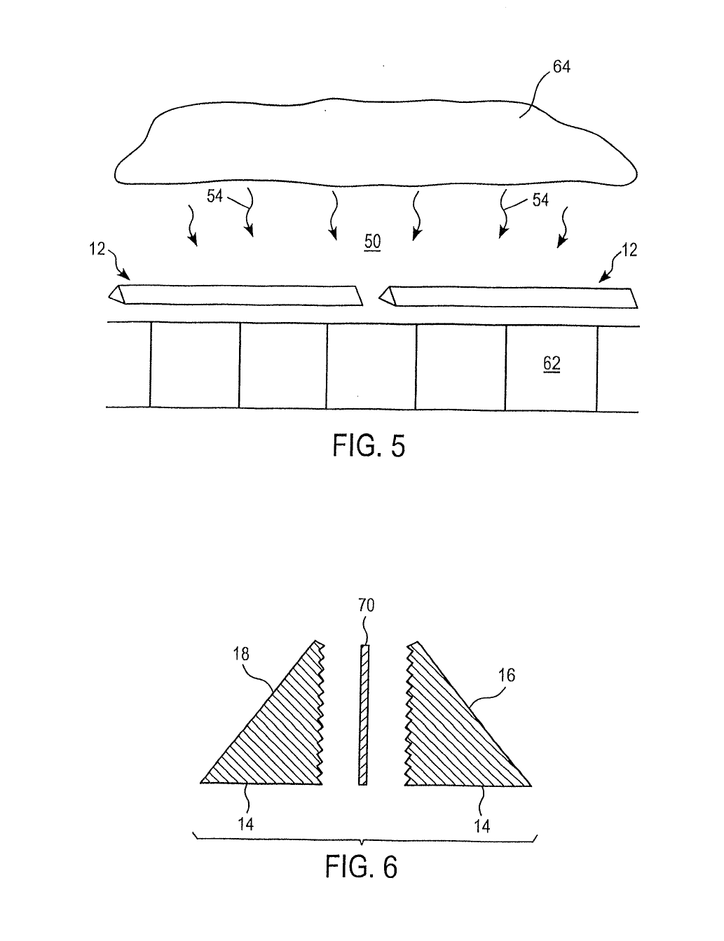

FIG. 5 illustrates linearly arranging the elongated body 12 along a sidewalk 62 to inhibit the water 54 flowing towards the sidewalk 62 from depositing debris on the sidewalk 62. The elongated body 12 is positioned between the loose debris 64 and the sidewalk 62. Multiple elongated bodies 12 can be linearly arranged along the sidewalk 62 as shown in FIG. 5. It may be preferable to construct the elongated bodies 12 of FIG. 5 with first and second side faces 16 and 18 each having respective widths W1 and W2 of about 3 inches. In a different embodiment (not shown), the elongated body 12 is bent around a circular storm drain inlet to filter debris from water flowing into the storm drain inlet. An elongated body 12 with respective widths W1 and W2 of 3 inches can serve as a suitable substitute for a un-stacked gravel bag.

Various modifications can be made to the elongated body 12 illustrated in FIGS. 1-5. For example, at least some of the edges 24, 26, and 28 can be rounded to lessen the impulse experienced by a vehicle passing over the elongated body 12. The first and second faces 16 and 18 can be curved (in a concave direction, a convex direction, or both the concave and convex directions) to lessen the impulse experienced by a passing vehicle. The first and second faces 16 and 18 can be curved such that the cross-section of the elongated body 12 orthogonal to the longitudinal axis of the elongated body 12 possessing an arch-like or semicircular shape. To help prevent the elongated body 12 from being moved out of position, the bottom face 14 can be adhered to the surface 50 by an adhesive.

The elongated body 12 can have more than two side faces. For example, the elongated body 12 may possess four side faces, each side face being angled relative to the adjacent intersecting side faces. In one embodiment, the elongated body 12 can possess three side faces, two of the side faces being angled relative to the bottom face 14 and the other side face being planar and substantially parallel to the bottom face 14.

Only a portion of the width W3 of the bottom face 14 may be planar. For instance, the end portions of the bottom face 14 near the edges 24 and 28 may be planar, and the middle portion of the bottom face 14 may possess a concave shape so that the middle portion of the bottom face 14 does not contact the surface 50.

The elongated body 12 can be flipped in multiple ways to accommodate different installation conditions. For example, the elongated body 12 may be arranged so that the side face 16, rather than the bottom face 14, rests in contact with the surface 50.

FIG. 6 illustrates a modification of the elongated body 12 wherein a fabric layer 70 is positioned inside the elongated body 12 so that the fabric layer is completely covered by the elongated body 12. FIG. 6 shows a cross-sectional view of the elongated body 12 including a fabric layer 70 in which the side portions of the elongated body 12 have been separated for illustrative purposes. The fabric layer 70 depicted in FIG. 6 extends along the longitudinal length L1 of the elongated body 12. The fabric layer 70 may filter fine debris or particulates from the water 52 passing through the elongated body 12 which are not otherwise removed from the water 52 by the rubber fibers of the elongated body 12. An exemplary material for the fabric layer 70 is MIRAFI fabric. Other fabric layers conventionally used with sediment barriers can also be used for the fabric layer 70. In addition to, or as an alternative to, embedding the fabric layer 70 within the elongated body 12 as shown in FIG. 6, the fabric layer 70 may cover at least a portion of the exterior of the elongated body 12. The fabric layer 70 can be held to the rubber fibers of the elongated body 12 by an adhesive.

The fibers forming the elongated body 12 can be made of materials other than rubber. For example, the fibers can be made of a polymer such as an elastomer. Additionally, the elongated body 12 can be formed of fibers of different materials such as a mixture rubber fibers and polymer fibers.

One benefit of constructing the elongated body 12 of a plurality of compressed, adhesive-bonded fibers is that the elongated body 12 is relatively durable. The elongated body 12 is not substantially damaged if run over by a vehicle. The elongated body 12 does not tend to disintegrate after repeated exposure to weather conditions such as rain, wind, sun and temperature changes. Because the elongated body 12 is relatively durable and does not easily break apart, the possibility of the elongated body 12 disintegrating into smaller pieces and adding to the surface debris of the construction site is reduced.

The durability of the elongated body 12 also enables the re-use of the elongated body 12 on multiple projects and/or multiple construction sites. The debris filtered by the elongated body 12 can be cleaned from the elongated body 12 and the elongated body 12 can be re-deployed on another construction site and/or project. In part because the elongated body 12 is relatively durable, some states will permit the elongated body 12 to be used on paved surfaces. Manufacturing the elongated body 12 has a relatively small environmental impact and low cost because the fibers of the elongated body 12 can be recycled materials such as recycled rubber tires.

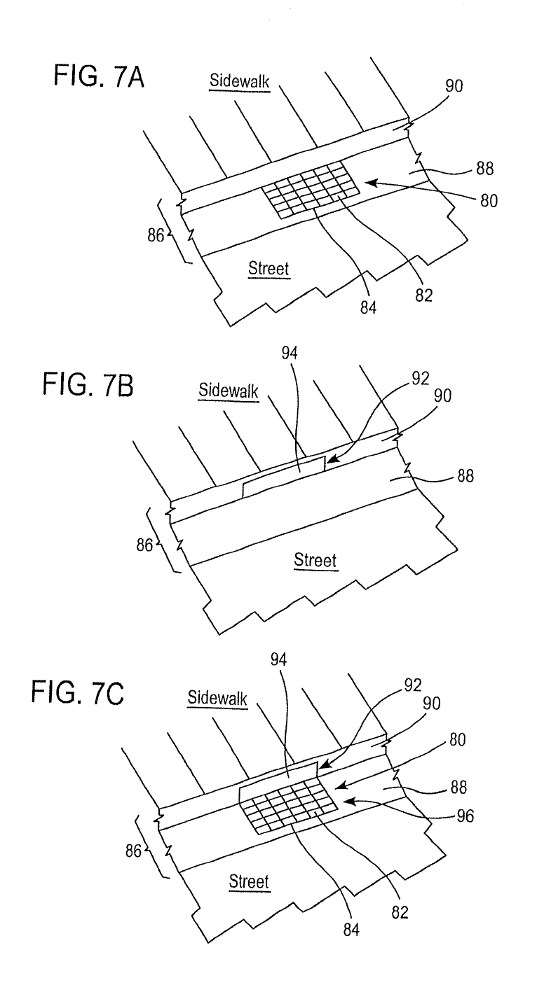

FIGS. 7-13 relate to a second embodiment of the filtering device. This embodiment of the filtering device is formed of the same materials as the first embodiment of the filtering device described above. As such, the description set forth above concerning the materials and manufacturing of the first embodiment of the filtering device applies equally to the second embodiment of the filtering device detailed below.

The second embodiment of the filtering device is generally used to filter water flowing into a pavement inlet leading to a storm drain. There are three common types of pavement inlets: (1) a gutter inlet 80 including a hole 82 formed in a horizontal portion 88 (that is, the gutter) of a curb 86 and a grate 84 covering the hole 82, as shown in FIG. 7A; (2) a curb inlet 92 including a hole 94 formed in a vertical portion 90 of the curb 86, as shown in FIG. 7B; and (3) a combination inlet 96 including both a gutter inlet 80 and a curb inlet 92, as shown in FIG. 7C.

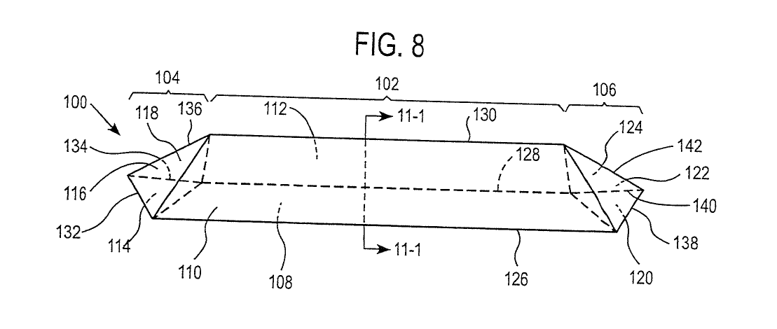

FIG. 8 illustrates a perspective view of the second embodiment of the filtering device. The filtering device of FIG. 8 includes an elongated body 100 possessing a middle portion 102, a first tapered end portion 104, and a second tapered end portion 106. The middle portion 102 extends between the first tapered end portion 104 and the second tapered end portion 106.

The middle portion 102 includes three faces: (1) a bottom face 108, (2) a front face 110, and (3) a rear face 112. The first tapered end portion 104 includes three faces: (1) a bottom face 114, (2) a front face 116, and (3) a rear face 118. The second tapered end portion 106 includes three faces: (1) a bottom face 120, (2) a front face 122, and (3) a rear face 124.

The middle portion 102 possesses three edges: (1) a front edge 126, (2) a rear edge 128, and (3) a top edge 130. The front edge 126, the rear edge 128, and the top edge 130 of the middle portion 102 illustrated in FIG. 8 each possess the same length. The first tapered end portion 104 includes three edges: (1) an angled front edge 132, (2) a rear edge 134, and (3) a top edge 136. The second tapered end portion 106 includes three edges: (1) an angled front edge 138, (2) a rear edge 140, and (3) a top edge 142.

FIG. 8 illustrates that the angled front edge 132 of the first tapered end portion 104 extends from the front edge 126 of the middle portion 126 to the rear edge 134 of the first tapered end portion 104. The angled front edge 132 is angled relative to the front edge 126 and is angled relative to the rear edge 134. FIG. 8 depicts that the angled front edge 138 of the second tapered end portion 106 extends from the front edge 126 of the middle portion 126 to the rear edge 138 of the second tapered end portion 106. The angled front edge 138 is angled relative to the front edge 126 and is angled relative to the rear edge 138.

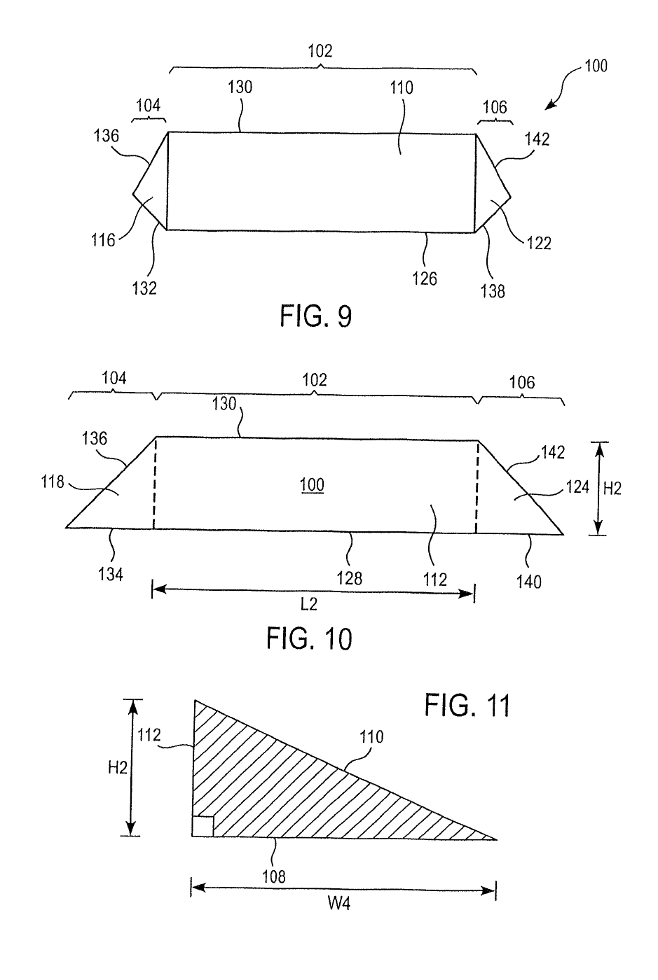

FIG. 9 illustrates a top view of the elongated body 100 depicted in FIG. 8.

FIG. 10 illustrates a rear view of the elongated body 100. FIG. 10 shows that the middle portion 102 possesses a length of L2. FIG. 10 shows that the rear edge 128 and the top edge 130 of the middle portion 102 possess the same length (that is, length L2). FIG. 10 shows that the rear edge 128 of the middle portion 102 extends between the first tapered end portion 104 and the second tapered end portion 106. FIG. 10 shows that the rear edge 134 of the first tapered end portion 104 extends away from the rear edge 128 of the middle portion 102. FIG. 10 illustrates that the rear edge 140 of the second tapered end portion 106 extends away from the rear edge 128 of the middle portion 102.

FIG. 11 illustrates a cross-sectional view of the middle portion 102 of the elongated body 100 taken along line 11-1 of FIG. 8. Line 11-1 is an imaginary line orthogonal to the longitudinal axis of the elongated body 100. The middle portion 102 of the elongated body may possess the same triangular cross-section along the entire length L2 of the middle portion 102. FIG. 11 depicts the bottom face 108 of the middle portion being substantially planar across the entire width W4 of the bottom face 108. In other embodiments, only a portion of the bottom face 108 may be planar. FIG. 11 shows that the front face 110 and the rear face 112 of the middle portion 102 are angled relative to the bottom face 108 so that the cross-section of the middle portion 102 is generally triangular. The bottom face 108 and the rear face 112 orthogonally intersect each other. In other embodiments, the bottom face 108 and the rear face 112 do not orthogonally intersect.

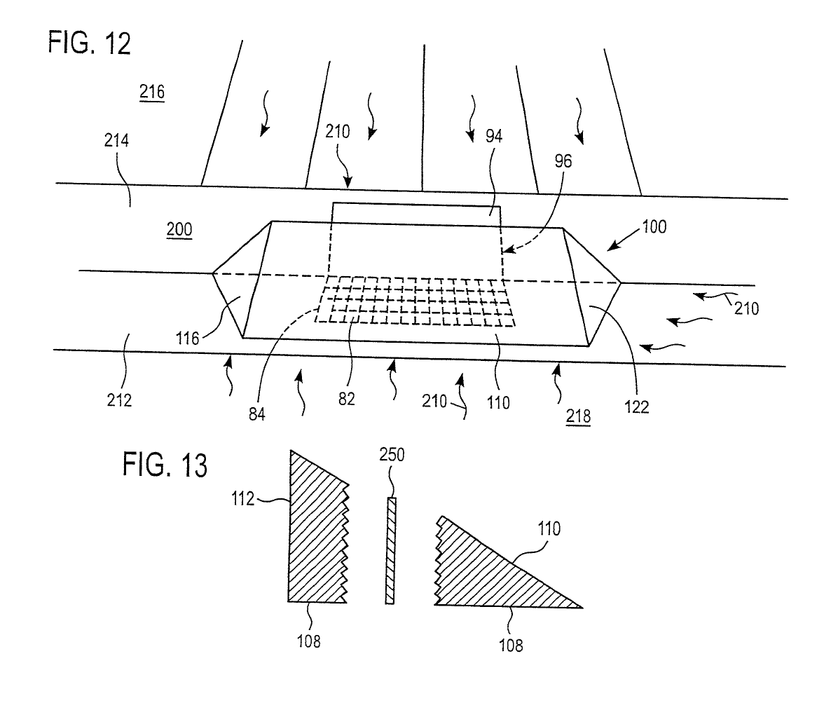

In one embodiment, the height H2 of the rear face 112 of the middle portion is approximately 6 inches. This may be a desirable height for the rear face 112 because the vertical height the curb inlet opening (e.g., hole 94) is generally about 6-8 inches. When the curb inlet opening is taller than the filtering device, the filtering device does not completely cover the curb inlet opening as shown in FIG. 12. The resulting gap between the top of the filtering device and the upper face of the curb inlet opening helps prevent water from pooling in front of the filtering device during a heavy rainstorm. If the water level rises above the filtering device, the water will flow into the curb inlet through the gap, in addition to flowing into the curb inlet through the filtering device. Thus, water is inhibited from flooding the street near the curb inlet.

In one embodiment, the width W4 of the bottom face 108 of the middle portion is approximately 16 inches. This may be a desirable width for the bottom face 108 because the width of the hole of many gutter inlets is about 16 inches. The length L2 of the middle portion is generally about 4 feet but can be varied depending on the length of the pavement inlet.

The elongated body 100 may be formed of a plurality of compressed rubber fibers bonded together with an adhesive similar to the elongated body 12 of the first embodiment described above. The porosity of the elongated body 100 is such that the elongated body 100 is permeable like the elongated body 12 of the first embodiment. Liquids such as water can pass through the elongated body 100, but construction site debris, such as gravel, rocks, silt, sand, and chipped or broken concrete and asphalt, etc., generally cannot pass through the elongated body 12.

FIG. 12 illustrates positioning the elongated body 100 along a curb 200 adjacent a pavement inlet so that the elongated body 100 filters debris from water 210 flowing into the pavement inlet. The rear faces 112, 118 and 124 (i.e., upright faces) of the elongated body 100 are pushed into substantially flush contact with the vertical face 214 of the curb 200. The planar bottom faces 108, 114, and 120 of the elongated body 100 rest, in part, against the horizontal face 212 of the curb 200.

The pavement inlet illustrated in FIG. 12 is a combination inlet 96 (FIG. 7C) including both a gutter inlet 80 and a curb inlet 92. The elongated body 100 can also be positioned to filter water flowing into other types of pavement inlets such as gutter inlets 80 (FIG. 7A) and curb inlets 92 (FIG. 7B). The water 210 flows in multiple directions towards the elongated body 100 during, for example, a rainstorm. Some water 210 flows along the horizontal portion 212 of the curb 200 toward the elongated body. Other water 210 flows from the sidewalk 216 toward the elongated member 100. Water from the street 218 also flows towards the elongated body 100.

The water 210 flowing toward the elongated body 100 contacts at least one of the front face 110 of the middle portion 102, the front face 116 of the first tapered end portion 104, and the front face 122 of the second tapered end portion 106. At least a portion of the water 210 passes through the elongated body 100 because the elongated body 100 is permeable. The empty space between the rubber fibers of the elongated body 100 permits the water 210 to pass through the elongated body 100. After passing through the elongated body 100, the water 210 flows out of the elongated body 100 through at least one of bottom faces 108, 114, and 120 into the hole 82 of the gutter inlet 80 and/or through at least one of the rear faces 112, 118, and 124 into the hole 92 of the curb inlet 92. Some of the water 210 flowing into contact with the elongated body 100 may not pass through the elongated body 100 and instead is diverted by the elongated body 100 so that the water 210 continues to flow down the curb line.

The debris carried by the flow of water 210 is substantially filtered from the water 210 as the water 210 passes through the elongated body 100. This is because at least some of the debris is not small enough to pass through the empty spaces between the rubber fibers of the elongated body 100. As such, the rubber fibers inhibit the debris carried by the water 210 from passing through the elongated body 100 and into the storm drain. The debris which does not pass through the elongated body 100 either gathers around the bottom edges of the elongated body 100 or becomes trapped inside the elongated body 100.

Because debris is substantially filtered from the water 210, the water 210 flowing out of the elongated body 100 may have a different pH and/or a different turbidity than the water 210 flowing into the elongated body 100. For example, the water 210 flowing out of the elongated body 100 may have a lower pH and/or a lower turbidity than the water 210 flowing into the elongated body 100. This aspect of the elongated body 100 may help a construction site operator comply with government regulations regulating the water properties of construction site rainwater runoff.

Vehicles such as cars, trucks, and earth-moving machinery may pass over the elongated body 100 after the elongated body 100 has been arranged to cover the pavement inlet as shown in FIG. 12. These vehicles in most instances will initially impact either the first tapered end portion 104 or the second tapered end portion 106 depending on which direction the vehicle is travelling. The slope the front surface 116 of the first tapered end portion 104 and the slope of the front surface 122 of the second tapered end portion 104 help reduce the impact of the passing vehicle against the elongated body 100. This diminishes the impulse experienced by the vehicle when passing over the elongated boy 100 and lessens the possibility of the vehicle pushing the elongated body 100 out of position.

An additional measure to inhibit the elongated body 100 from being moved out of position is to drive a stake or spike through the elongated body 100 and into the ground beneath elongated body 100. Wooden and/or steel spikes can be used for this purpose.

The elongated body 100 illustrated in FIGS. 8-12 can be modified in various ways. For example, at least some of the edges of the elongated body 100 and/or at least some of the front faces 108, 116, and 112 of the elongated body 100 can be rounded and/or curved to lessen the impulse experience by a vehicle passing over the elongated body 100. The elongated body 100 can be constructed without the first and second tapered end portions 104 and 106 so that the ends of the elongated body 100 are squared off rather than being sloped or tapered. The first and second tapered end portions 104 and 106 can be made detachable from the middle portion 102. This allows a longer middle portion to be substituted for the middle portion 102 when the elongated body 100 is to be positioned adjacent a long pavement inlet. The detachable tapered end portions may be releasably attached to the middle portion 102 with a fastener, such as a strap, and/or an adhesive. Instead of having a linear profile as illustrated in FIG. 8-12, the elongated body 100 can possess a curved profile so that the elongated body 100 can be placed in front of a curved pavement inlet wrapping around the curb of a street corner.

FIG. 13 illustrates a modification of the elongated body 100 wherein a fabric layer 250 is positioned inside the elongated body 100 so that the fabric layer 250 is completely covered by the elongated body 100. FIG. 13 shows a cross-sectional view of the middle portion 102 of the elongated body 100 including the fabric layer 250 in which the front and rear portions of the middle portion 102 have been separated for illustrative purposes. The fabric layer 250 depicted in FIG. 13 extends along the length L2 of the middle portion 102. The fabric layer may also extend through the first and second tapered end portions 104 and 106. The fabric layer 250 may filter fine debris or particulates from the water 210 passing through the elongated body 100 which are not otherwise removed from the water 210 by the rubber fibers of the elongated body 100. An exemplary material for the fabric layer 250 is MIRAFI fabric. Other fabric layers conventionally used in sediment barriers can also be used for the fabric layer 250. In addition to, or as an alternative to, embedding the fabric layer 250 within the elongated body 100 as shown in FIG. 13, the fabric layer 250 may cover at least a portion of the exterior of the elongated body 100. The fabric layer 250 can be held to the rubber fibers of the elongated body 250 by an adhesive.

The fibers forming the elongated body 100 can be made of materials other than rubber. For example, the fibers can be made of a polymer such as an elastomer. Additionally, the elongated body 100 can be formed of fibers of different materials such as a mixture rubber fibers and polymer fibers.

One benefit of constructing the elongated body 100 of a plurality of compressed, adhesive-bonded fibers is that the elongated body 100 is relatively durable and can be re-used as discussed above. In part because the elongated body 100 is relatively durable, some states will permit the elongated body 100 to be used on paved surfaces. Manufacturing the elongated body 100 has a relatively small environmental impact and low cost because the fibers of the elongated body 100 can be recycled materials such as recycled rubber tires.

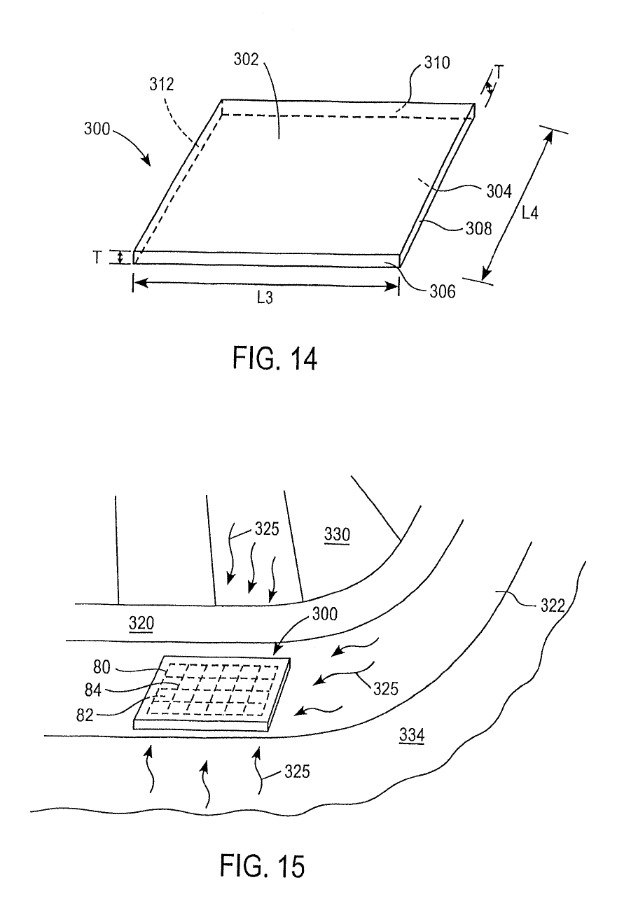

FIGS. 14-16 relate to a third embodiment of the filtering device. This embodiment of the filtering device is formed of the same materials as the first embodiment of the filtering device described above. As such, the description set forth above about the materials and manufacturing of the first embodiment of the filtering device applies equally to the third embodiment of the filtering device detailed below.

The third embodiment of the filtering device is generally used to filter water flowing into a pavement inlet such as a gutter inlet 80 (FIG. 7A). FIG. 14 illustrates a perspective view of the third embodiment of the filtering device. The filtering device of FIG. 14 includes an elongated body 300 possessing a planar bottom face 302 and a planar top face 304. The top and bottom faces 302 and 304 can be rectangular as shown in FIG. 14 or any other shape sufficient to cover the hole of the pavement inlet. The elongated body 300 possesses a thickness T which is generally about 1.5 inches. In one embodiment, the lengths L3 and L4 of the elongated body 300 are each about 4 feet. The side faces 306, 308, 310, and 312 may be sloped or tapered to facilitate vehicles passing over the elongated body 300. Alternatively, the side faces 306, 308, 310, and 312 may be squared off.

FIG. 15 illustrates positioning the elongated body 300 to cover the grate 84 of the gutter inlet 80 so that the elongated body 300 filters debris from the water 325 flowing into the hole 82 of the gutter inlet 80. The water 325 flows in multiple directions towards the elongated body 300 during, for example, a rainstorm. Some water 325 flows along the horizontal portion 322 of the curb 320 toward the elongated body. Other water 325 flows from the sidewalk 330 toward the elongated member 300. Water from the street 334 also flows towards the elongated body 300.

The water 325 flowing toward the elongated body 300 contacts at least one of the top 302 and the side faces 306, 308, 310, and 312 face of the elongated body 300. At least a portion of the water 325 passes through the elongated body 300 because the elongated body 300 is permeable. The empty space between the rubber fibers of the elongated body 300 permits the water 325 to pass through the elongated body 300. After passing through the elongated body 300, the water 325 flows out of the elongated body 325 through the bottom face 304 into the hole 82 of the gutter inlet 80. Some of the water 325 flowing into contact with the elongated body 300 may not pass through the elongated body 300 and instead is diverted by the elongated body 300 so that the water 325 continues to flow down the curb line.

The debris carried by the flow of water 325 is substantially filtered from the water 325 as the water 325 passes through the elongated body 300. This is because at least some of the debris is not small enough to pass through the empty spaces between the rubber fibers of the elongated body 300. As such, the rubber fibers inhibit the debris carried by the water 325 from passing through the elongated body 300 and into the storm drain. The debris which does not pass through the elongated body 300 either gathers around the bottom edges of the elongated body 300 or becomes trapped inside the elongated body 300.

Because debris is substantially filtered from the water 325, the water 325 flowing out of the elongated body 300 may have a different pH and/or a different turbidity than the water 325 flowing into the elongated body 300. For example, the water 325 flowing out of the elongated body 300 may have a lower pH and/or a lower turbidity than the water 325 flowing into the elongated body 300. This aspect of the elongated body 300 may help a construction site operator comply with government regulations regulating the water properties of construction site rainwater runoff.

The elongated body 300 illustrated in FIGS. 14 and 15 can be modified in various ways. For example, at least some of the edges of the elongated body 300 and/or at least some of the faces 302, 304, 306, 308, 310, and 312 can be rounded and/or curved to lessen the impulse experience by a vehicle passing over the elongated body 300.

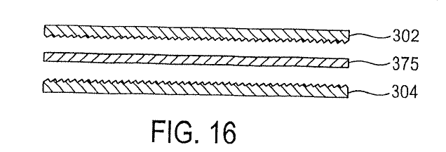

FIG. 16 illustrates a modification of the elongated body 300 wherein a fabric layer 375 is positioned inside the elongated body 300 so that the fabric layer 375 is completely covered by the elongated body 300. FIG. 16 shows a cross-sectional view of the elongated body 300 including a fabric layer 375 in which the top and bottom portions of the elongated member 300 have been separated for illustrative purposes. The fabric layer 375 depicted in FIG. 16 extends along the length L4 of the elongate member 300. The fabric layer 375 may filter fine debris or particulates from the water 325 passing through the elongated body 300 which are not otherwise removed from the water 325 by the rubber fibers of the elongated body 300. An exemplary material for the fabric layer 375 is MIRAFI fabric. Other fabric layers conventionally used in sediment barriers can also be used. In addition to, or as an alternative to, embedding the fabric layer 375 within the elongated body 300 as shown in FIG. 16, the fabric layer 375 may cover at least a portion of the exterior of the elongated body 300. The fabric layer 375 can be held to the rubber fibers of the elongated body 375 by an adhesive.

The fibers forming the elongated body 300 can be made of materials other than rubber. For example, the fibers can be made of a polymer such as an elastomer. Additionally, the elongated body 300 can be formed of fibers of different materials such as a mixture rubber fibers and polymer fibers.

One benefit of constructing the elongated body 300 of a plurality of compressed, adhesive-bonded fibers is that the elongated body 300 is relatively durable and can be re-used as discussed above. In part because the elongated body 300 is relatively durable, some states will permit the elongated body 300 to be used on paved surfaces. Manufacturing the elongated body 300 has a relatively small environmental impact and low cost because the fibers of the elongated body 300 can be recycled materials such as recycled rubber tires.

To inhibit the elongated body 300 from being moved out of position is to drive a stake or spike through the elongated body 300 and into the ground beneath elongated body 300. Wooden and/or steel spikes can be used for this purpose.

The filtering device of each of the embodiments has been described primarily in terms of use with storm drains. However, the filtering device of the present application may be used to cover any inlet and/or hole into which fluid flows, including indoor drains.

While the invention has been described in connection with various embodiments, it will be understood that the invention is capable of further modifications. This application is intended to cover any variations, uses or adaptations of the invention following, in general, the principles of the invention, and including such departures from the present disclosure as, within the known and customary practice within the art to which the invention pertains.

What is claimed is:

1. A device for filtering debris from liquid flowing over a surface, the device comprising:
a flexible, permeable elongated body possessing a plurality of faces including a planar bottom face configured to rest on the surface;
the permeable elongated body being configured so that with the permeable elongated body resting on the surface, the liquid flowing over the surface contacts at least one of the faces of the permeable elongated body, passes through the permeable elongated body, and flows out of the permeable elongated body through at least one other of the faces of the permeable elongated body, wherein the permeable elongated body filters a portion of the debris from the liquid as the liquid passes through the permeable elongated body; and
the permeable elongated body being formed of a plurality of compressed rubber fibers and an adhesive bonding together the rubber fibers.

2. The device of claim 1, wherein the permeable elongated body possesses a triangular cross-section orthogonal to a longitudinal axis of the permeable elongated body.

3. The device of claim 1, wherein the plurality of faces includes a first side face angled relative to the planar bottom face and a second side face angled relative to the planar bottom face.

4. The device of claim 3, wherein the first side face orthogonally intersects the second side face.

5. The device of claim 3, wherein each of the first and second side faces possesses a width extending between opposing edges of the respective side face, the widths of the first and second side faces being equal.

6. The device of claim 5, wherein the width of each of the first and second side faces is between 3 and 8 inches.

7. The device of claim 1, wherein each of the rubber fibers possesses a length between 0.5 and 1.5 inches.

8. The device of claim 1, further comprising a fabric layer positioned inside and completely covered by the permeable elongated body so that at least a portion of the liquid passing through the permeable elongated body also passes through the fabric layer.

9. The device of claim 1, the plurality of faces including an upright face orthogonally intersecting the planar bottom face and possessing a width extending between opposing edges of the upright face, the width being at least 6 inches.

10. The device of claim 1, wherein the permeable elongated body possesses two tapered end portions and a middle portion extending between the two tapered end portions, the middle portion possessing a triangular cross-section orthogonal to a longitudinal axis of the permeable elongated body, the middle portion possessing front and rear edges extending between the two tapered end portions, each tapered end portion possessing a rear edge extending from the rear edge of the middle portion, and each tapered end portion possessing an angled front edge extending between the front edge of the middle portion and the rear edge of the tapered end portion.

11. The device of claim 1, the plurality of faces includes a planar top face parallel to the planar bottom face.

12. The device of claim 1, wherein a pH and/or a turbidity of the liquid changes as the liquid passes through the permeable elongated body.

13. A method of filtering debris from liquid flowing over a surface, the method comprising:
positioning on the surface a flexible, permeable elongated body possessing a plurality of faces and a plurality of compressed, adhesive-bonded fibers so that the liquid flowing over the surface flows towards the permeable elongated body; and
wherein positioning the permeable elongated body comprises arranging the permeable elongated body so that the liquid flowing towards the permeable elongated body contacts at least one of the faces of the permeable elongated body, passes through the permeable elongated body, and flows out of the permeable elongated body through at least one other of the faces of the permeable elongated body, and wherein the liquid passing through the permeable elongated body is filtered to remove at least a portion of the debris from the liquid as the liquid passes through the permeable elongated body.

14. The method of claim 13, wherein the plurality of faces of the permeable elongated body include a planar bottom face, a first side face angled relative to the planar bottom face, and a second side face angled relative to the planar bottom face, the permeable elongated body being arranged so that the liquid flowing towards the permeable elongated body contacts at least one of the first and second side faces.

15. The method of claim 14, wherein each of the first and second side faces possesses a width extending between opposing edges of the respective side face, the widths of the first and second side faces being equal, and the width of each of the first and second side faces being between 3 and 8 inches.

16. The method of claim 13, wherein the plurality of faces of the permeable elongated body include a planar bottom face and an upright face, the upright face orthogonally intersecting the planar bottom face, the upright face possessing a width extending between opposing edges of the upright face, and the width of the upright face being at least 6 inches.

17. The method of claim 13, wherein the permeable elongated body possesses two tapered end portions and a middle portion extending between the two tapered end portions, the middle portion possessing a triangular cross-section orthogonal to a longitudinal axis of the permeable elongated body, the middle portion possessing front and rear edges extending between the two tapered end portions, each tapered end portion possessing a rear edge extending from the rear edge of the middle portion, and each tapered end portion possessing an angled front edge extending between the front edge of the middle portion and the rear edge of the tapered end portion.

18. The method of claim 13, wherein positioning the permeable elongated body comprising bending the permeable elongated body into a semicircular shape or u-shape.

19. A filtering device positioned on a surface which conveys liquid carrying debris, comprising:
the filtering device comprising:
a flexible, permeable elongated body possessing a plurality of faces including a planar bottom face resting on the surface; and
the permeable elongated body being formed of a plurality of compressed fibers and an adhesive bonding together the fibers; and
the filtering device being positioned on the surface so that the liquid contacts at least one of the faces of the permeable elongated body, passes through the permeable elongated body, and flows out of the permeable elongated body through at least one other of the faces of the permeable elongated body, wherein the permeable elongated body filters a portion of the debris from the liquid as the liquid passes through the permeable elongated body.

20. The filtering device position on the surface of claim 19, the surface comprising a hole leading to a storm drain, the permeable elongated body extending across the hole, at least a portion of the liquid which has passed through the permeable elongated body flows out of the permeable elongated body through the planar bottom surface into the hole.

21. The filtering device position on the surface of claim 19, the surface comprising a debris pile, and the permeable elongated body possessing a semicircular shape or u-shape, the permeable elongated body least partially surrounding the debris pile.
